(19) United States
(12) Patent Application Publication
(10) Pub. No.: US 2021/0312071 A1
(43) Pub. Date: Oct. 7, 2021

(54) Method and apparatus for securing data in multiple independent channels

(71) Applicant: Sage Microelectronics Corporation, Hangzhou (CN)

(72) Inventors: Jianjun Luo, Hangzhou (CN); Chris Tsu, Hangzhou (CN); Fengbiao Wei, Hangzhou (CN); Bin Zhou, Hangzhou (CN)

(21) Appl. No.: 16/007,349

(22) Filed: Jun. 13, 2018

(30) Foreign Application Priority Data
Jun. 13, 2017 (CN) 210710443364.0

(51) Int. Cl. G06F 21/62; G06F 12/14; G06F 21/60; G06F 21/78

(52) U.S. Cl. CPC G06F 21/6227; G06F 21/78; G06F 21/602; G06F 12/1408

(57) ABSTRACT

Designs of integrated modules for securing data are described. According to one aspect of the present invention, a data set is distributed among a plurality of data channels, each of the data channels including an encrypting/decrypting module designed to process a data stream or set. Modules in the data channels work independently from each other. A next data stream is timely provided to a data channel when a current data stream is about to finish, resulting in increased efficiency when encrypting data from a source or decrypting encrypted data for a source.

### BACKGROUND OF THE INVENTION

### Field of Invention

The invention generally is related to the area of data security, and more particularly related to integrated devices for securing data in parallel channels, where encrypting or decrypting respective data sets in the parallel channels is performed independently from each other.

### Related Art

Various data is being created every moment and securing the data is increasingly demanded than ever. There are essentially two ways to secure the data, in software or in hardware. In some cases, securing data in software could be risky, subject to hacking while securing data in hardware is in general safer than in software.

Securing data in hardware, however, could be more costly when compared with securing data in software. If not designed properly, a data flow would be slowed down by the added process of securing the data. There are also issues in compatibilities when different manufacturers produce their own hardware devices, resulting in various inefficiencies in using the data. Accordingly, there is a need for devices that can secure the data while providing high efficiency in encrypting or decrypting data for real-time applications.

### SUMMARY OF THE INVENTION

This section is for the purpose of summarizing some aspects of the present invention and to briefly introduce some preferred embodiments. Simplifications or omissions in this section as well as in the abstract may be made to avoid obscuring the purpose of this section and the abstract. Such simplifications or omissions are not intended to limit the scope of the present invention.

The present invention generally pertains to designs of integrated modules for securing data. According to one aspect of the present invention, a data set is distributed among a plurality of data channels, each of the data channels including an encrypting/decrypting module designed to process a data stream. Modules in the data channels work independently from each other and entirely managed by a manager (a.k.a., a modules or channels manager). A next data stream is timely provided to a data channel when a current data stream is about to finish, resulting in increased efficiency when encrypting data from a source or decrypting encrypted data for a source.

Depending on implementation, the present invention may be implemented as a method, an apparatus or part of a system. According to one embodiment, the present invention is an apparatus for securing data, the apparatus comprises: an interface communicating with a data source and receiving an instruction therefrom, an array of data channels, each of the data channels including a channel control unit and one cipher engine; and a controller provided to manage operations of the data channels.

According to one embodiment, the present invention is a method for securing data, the method comprises: receiving, from a data source, data sets along with an instruction from an interface; providing an array of data channels, each of the data channels including a channel control unit and one cipher engine; feeding an appropriate number of the data sets to the data channels, wherein the data channels receive the data sets and encrypts or decrypts the data sets in parallel, and the data channels are not synchronized and operate independently from each other.

The instruction includes a tag for encryption or decryption. The channel control unit includes a channel interface to communicate independently with the controller. The data channels receives data sets and encrypts or decrypts the data sets in parallel, wherein the data channels are not synchronized and operate independently from each other.

One of the objects, features and advantages of the present invention is to provide an apparatus, a method or a system for securing data in parallel to maximize the data processing efficiency. Other objects, features, benefits and advantages, together with the foregoing, are attained in the exercise of the invention in the following description and resulting in the embodiment illustrated in the accompanying drawings.

### BRIEF DESCRIPTION OF THE FIGURES

These and other features, aspects, and advantages of the present invention will be better understood with regard to the following description, appended claims, and accompanying drawings where:

FIG. 1 shows an exemplary functional block diagram of parallel encryption and decryption in accordance with one embodiment thereof;

FIG. 2 shows a functional block diagram of an exemplary channel control unit used in FIG. 1 for data encryption and decryption;

FIG. 3 shows a functional block diagram of an exemplary cipher engine;

FIG. 4 shows an IC architecture of parallel encryption and decryption using eMMC interface according to the embodiment of FIG. 1;

FIG. 5 shows an IC architecture of a channel control unit that may be used in FIG. 4; and

FIG. 6 shows an IC architecture of a cipher engine that may be used in FIG. 4.

### DETAILED DESCRIPTION OF THE INVENTION

The detailed description of the invention is presented largely in terms of procedures, steps, logic blocks, processing, and other symbolic representations that directly or indirectly resemble the operations of communication devices coupled to networks. These process descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

One of the important objects, advantages and benefits in the present invention is to secure data in parallel through an array of cipher engines. To facilitate the description of the present invention, an encrypter or encrypters are used to encrypt a set of data. Those skilled in the art shall understand that the same encrypters may also be used to decrypt the encrypted data, hence decrypter or decrypters. Accordingly, when a cipher engine is used herein, it means either one of the encrypter and decrypter. Further as used herein, data means a set of binary digits (e.g., 1's or 02') that may be received from or stored in a source, or simply received from stored in a memory. An example of such memory is flash memory, a kind of memory that retains data in the absence of a power supply.

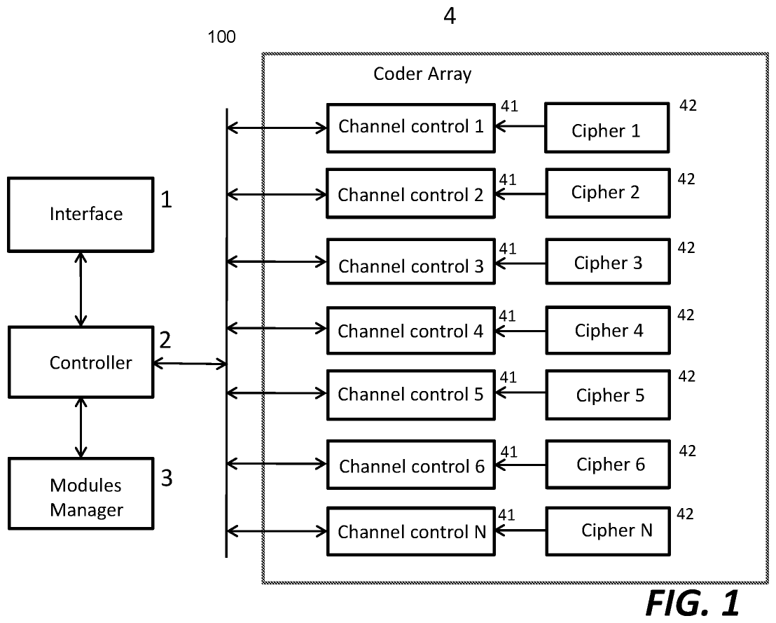

According to one embodiment, a set of data is processed in multiple channels, each channel is provided with a cipher engine coupled with a (channel) processing unit and a bus interface. As a result, the data can be encrypted/decrypted in parallel. Referring now to the drawings, in which like numerals refer to like parts throughout the several views. FIG. 1 shows an exemplary functional block diagram 100 of parallel encryption and decryption in accordance with one embodiment thereof. The system configuration 100 shows that there are an interface 1, a main controller 2 and a modules manager 3. The interface 1 receives an instruction whether incoming data needs to be encrypted or not. In practical applications, not all data needs to be encrypted. When a set of data (e.g., representing an important document) does need to be encrypted, an instruction (e.g., initiated by a user) is provided and activates the controller 2 to cause the modules manager 3 to manage/coordinate the operations of the module array 4 to encrypt or secure the data in parallel according to an encryption scheme.

The module array 4 includes an array of channel control units 41 and cipher engines 42, where each of the channel control units corresponds to one cipher engine. In another perspective, there are one channel control unit and one cipher engine for each data channel, where each data channel works independently from each other, all the data channels are managed by the modules manager 3. According to one embodiment of the present invention, the modules manager 3 is designed to monitor the status of each data channel. In operation, the modules manager 3 dynamically allocates data streams to a data channel whenever the data channel becomes available to process a next data stream, thus maximizing the encrypting efficiency. Likewise, the modules manager 3 dynamically allocates encrypted data sets or streams to a data channel whenever the data channel becomes available to decrypt a next data stream, thus maximizing the decrypting efficiency. Subject to an instruction from the modules manager 3, a data channel performs encryption or decryption for a data source. Depending in the implementation, the instruction includes an indicator (for encryption or decryption), and one or more sequence numbers for a data set.

According to one embodiment of the present invention, the interface between a channel control unit and a cipher engine may be based on one of the industry standards, such as eMMC (Embedded Multi Media Card), UFS (Universal Flash Storage), SATA (Serial Advanced Technology Attachment), SPI (Serial Peripheral Interface) and etc.

One of the important advantages, objectives and benefits in the present invention is that the encrypting/decrypting operations are independently performed in respective channels. In other words, their operations are not synchronized. In operation, sizes of data sets or streams can be very different. When one channel is about to finish one data stream, another data stream is timely provided thereto for encryption or decryption, regardless of the status of other data channels, thus maximizing the use of the data channels while increasing the encrypting/decrypting efficiency considerably. Depending on the implementation, a commonly used encoding/decoding scheme may used in a cipher engine, such as RSA (Rivest-Shamir-Adleman, one of the first public-key cryptosystems), AES (Advanced Encryption Standard), SM2 (Public key cryptographic algorithm SM2 based on elliptic curves), SM4 (a block cipher used in the Chinese National Standard for Wireless LAN WAPI) and others.

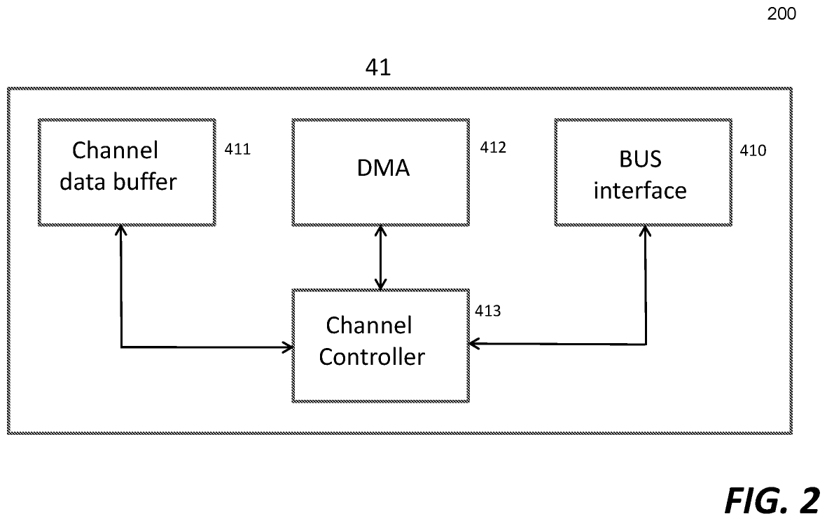

Referring now to FIG. 2, it shows a functional block diagram of an exemplary channel control unit that may be used in FIG. 1 for data encryption and decryption. As shown in FIG. 2, the configuration 200 includes an interface 410, a data buffer 411, a DMA module 412, and a channel controller 413. The interface 410 is provided to couple the control unit 41 to a cipher engine 42. The data buffer 411 is provided to buffer a data set from, e.g., the controller 2 or a data source. The DMA (Direct Memory Access) module 412 is provided to allow direct access to the data set. The channel controller 413 is provided to control the operation of the DMA module 412. In operation, the channel controller 413 is designed to instruct the cipher engine 42 to perform encryption or decryption on the data set. It can be appreciated that the data set may be from a file to be encrypted or part of encrypted data to be decrypted.

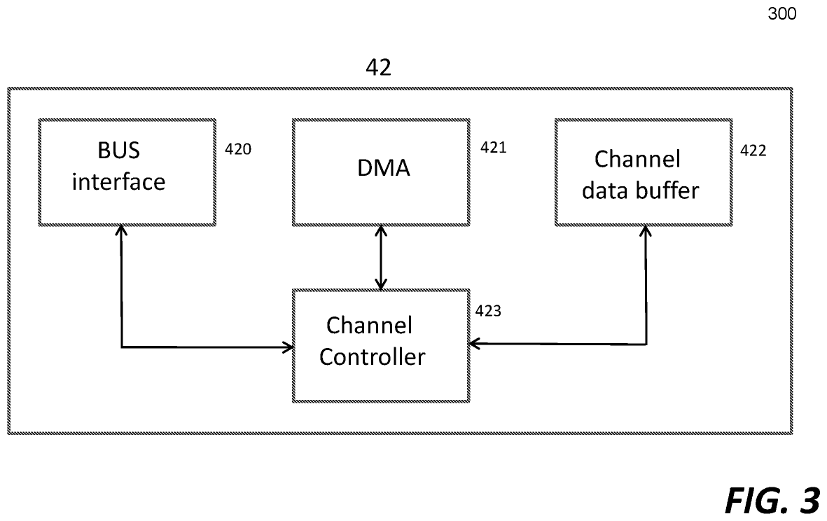

FIG. 3 shows a configuration 300 of an exemplary cipher engine 42 that may be used in FIG. 1 for data encryption or decryption. As shown in FIG. 3, the configuration 300 includes an interface 420, a DMA module 421, a data buffer 422 and a channel controller 423. The interface 420 is provided to couple the cipher engine 42 to the control unit 41. The DMA (Direct Memory Access) module 421 is provided to allow access to a data set directly. The channel controller 423 is provided to control the operation of the DMA module 421. The data buffer 422 is provided to buffer a data set. According to one embodiment, the cipher engine 42 is where data gets encrypted or decrypted and implemented in an integrated circuit (IC) or part of an IC.

In operation, an instruction to encrypt or decrypt a set of data is received, the controller 2 sends the instruction to each of the data channels along with a date set to be encrypted or decrypted. The processed data is then returned to the controller 2.

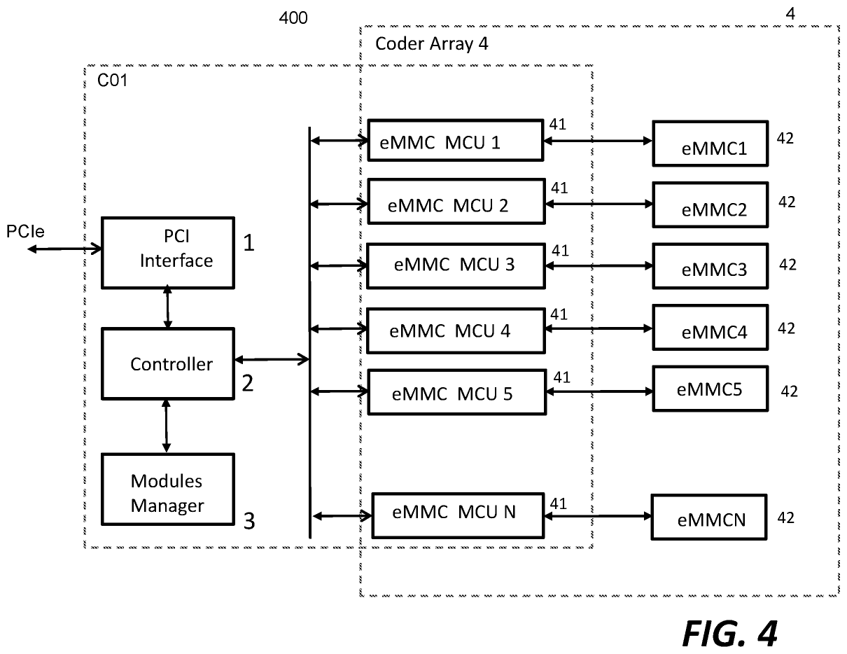

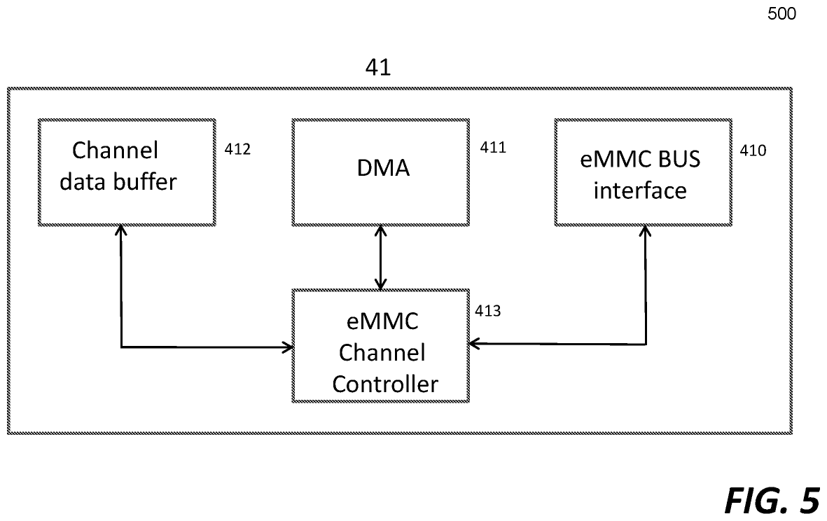

FIG. 4 shows an exemplary integrated circuit (IC) architecture based on an interface PCIe. In reference to FIG. 1, all the components: PCIe interface 1, controller 2, modules manager 3 and the processing array 4, may be integrated in one single chip C01 or more chips. In one embodiment, as shown in FIG. 5, channel controllers 413 are implemented using an eMMC controller (e.g., from Silicon Motion, Inc.), the cipher engine 42 is also implemented on a single chip dedicated to encrypt or decrypt data. Thus in one embodiment, the array 4 is implemented using a number of eMMC controllers and one or more encrypting/decrypting ID chips.

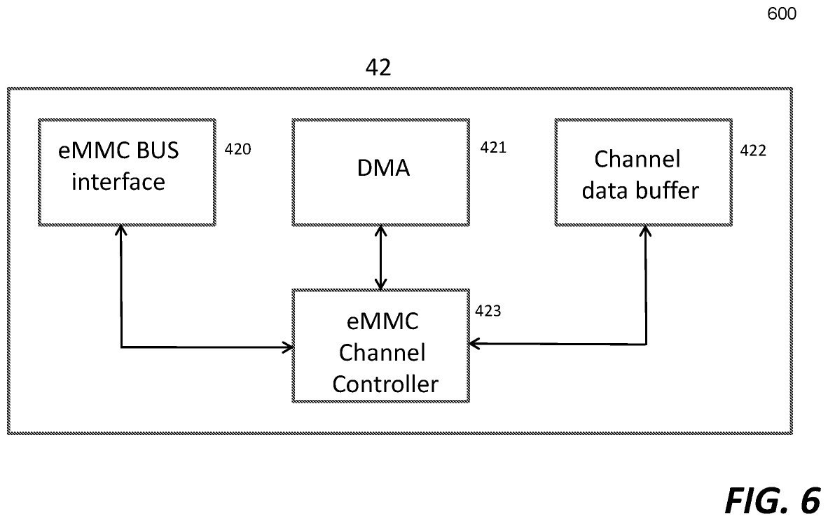

FIG. 5 shows the corresponding implementation of the channel control unit 41 based on the standard of eMMC, in reference to FIG. 2. It should be noted that the bus interface 1 may be implemented using one of the standards, such as eMMC or SD. FIG. 6 also shows the corresponding implementation of the cipher engine 42 based on the standard of eMMC. It should be noted that the encryption/decryption may be implemented using any one of the well-known schemes such as AES, ECC, SHA, and DES.

While the present invention has been described with reference to specific embodiments, the description is illustrative of the invention and is not to be construed as limiting the invention. Various modifications to the present invention can be made to the preferred embodiments by those skilled in the art without departing from the true spirit and scope of the invention as defined by the appended claim. Accordingly, the scope of the present invention is defined by the appended claims rather than the forgoing description of embodiments.

We claim:

1. An apparatus for securing data, the apparatus comprising:
an interface communicating with a data source and receiving an instruction therefrom, wherein the instruction includes a tag for encryption or decryption;
an array of data channels, each of the data channels including a channel control unit and one cipher engine;
a controller provided to manage operations of the data channels, wherein the channel control unit includes a channel interface to communicate independently with the controller, the data channels receiving data sets and encrypting or decrypting the data sets in parallel, and wherein the data channels are not synchronized and operate independently from each other.

2. The apparatus as recited in claim 1, wherein one of the data channels is initially fed with a first data set for processing, and is immediately fed with a second data set as soon as the one of the data channels is done with the first data set, regardless of how others of the data channels are processing respective data sets.

3. The apparatus as recited in claim 1, wherein the data channels are initially caused to encrypt the data sets, one of the data channels is caused to decrypt a data set as soon as the one of the data channels is done with one of the data sets, regardless of how others of the data channels are processing the data sets.

4. The apparatus as recited in claim 1, wherein the channel control unit further includes a data buffer to buffer a data set and a DMA to access the data set directly.

5. The apparatus as recited in claim 4, wherein the instruction further includes one or more sequence numbers to identify respectively the data sets.

6. The apparatus as recited in claim 5, wherein the channel interface is based on an industry standard.

7. The apparatus as recited in claim 6, wherein the industry standard is one of eMMC (Embedded Multi Media Card), UFS (Universal Flash Storage), SATA (Serial Advanced Technology Attachment), and SPI (Serial Peripheral Interface).

8. The apparatus as recited in claim 1, wherein the interface is based on an industry standard.

9. The apparatus as recited in claim 8, wherein the interface is one of USB, IDE, SATA, SAS, PCIE, and NVME.

10. A method for securing data, the method comprising:
receiving, from a data source, data sets along with an instruction from an interface, wherein the instruction includes a tag for encryption or decryption;
providing an array of data channels, each of the data channels including a channel control unit and one cipher engine;
feeding an appropriate number of the data sets to the data channels, wherein the data channels receive the data sets and encrypts or decrypts the data sets in parallel, and the data channels are not synchronized and operate independently from each other.

11. The method as recited in claim 10, wherein the channel control unit includes a channel interface to communicate independently with a controller to receive a data set for encryption or decryption.

12. The method as recited in claim 11, wherein one of the data channels is initially fed with a first data set for processing, and is immediately fed with a second data set as soon as the one of the data channels is done with the first data set, regardless of how others of the data channels are processing respective data sets.

13. The method as recited in claim 11, wherein the data channels are initially caused to encrypt the data sets, one of the data channels is caused to decrypt a data set as soon as the one of the data channels is done with one of the data sets, regardless of how others of the data channels are processing the data sets.

14. The method as recited in claim 10, wherein the channel control unit further includes a data buffer to buffer a data set and a DMA to access the data set directly.

15. The method as recited in claim 14, wherein the instruction further includes one or more sequence numbers to identify respectively the data sets.

16. The method as recited in claim 15, wherein the channel interface is based on an industry standard.

17. The method as recited in claim 16, wherein the industry standard is one of eMMC (Embedded Multi Media Card), UFS (Universal Flash Storage), SATA (Serial Advanced Technology Attachment), and SPI (Serial Peripheral Interface).

18. The method as recited in claim 10, wherein the interface is based on an industry standard.

19. The apparatus as recited in claim 18, wherein the interface is one of USB, IDE, SATA, SAS, PCIE, and NVME.
